(19) United States
(12) Patent Application Publication
(10) Pub. No.: US 2026/0267657 A1
(43) Pub. Date: Sep. 10, 2026

(54) SYSTEMS AND METHODS OF TRANSITIONING COPROCESSORS BETWEEN BOOT ENVIRONMENTS

(71) Applicant: Qualcomm Technologies, Inc., San Diego, CA (US)

(72) Inventors: Claudia DE ANDRADE, San Diego, CA (US); Christopher LEW, San Diego, CA (US); Bjorn ANDERSSON, Austin, TX (US); Aishwarya RANGARAJ, San Diego, CA (US); Gaurang PARIKH, San Diego, CA (US)

(73) Assignee: Qualcomm Technologies, Inc., San Diego, CA (US)

(21) Appl. No.: 19/073,464

(22) Filed: Mar. 7, 2025

(51) Int. Cl. G06F 9/4401; G06F 9/54

(52) U.S. Cl. CPC G06F 9/4403; G06F 9/4406; G06F 9/544

(57) ABSTRACT

A multiprocessor system includes an apps processor configured to boot to a high level operating system (HLOS); a coprocessor configured to boot via a boot sequence and transition to the HLOS; and a shared memory wherein the shared memory is writable by the coprocessor during the boot sequence and readable by the apps processor. The apps processor is further configured to modify the transition of the coprocessor to the HLOS in response to one or more signals written to the shared memory by the coprocessor. Other methods and systems are disclosed herein.

### FIELD OF THE DISCLOSURE

The present disclosure relates generally to booting multiprocessor systems and, more specifically, to transitioning coprocessors of multiprocessor systems between boot environments and to high level operating systems.

### BACKGROUND

Many devices, such as smartphones, computers, and other complex electronic devices are operated by software and, thus, may include a plurality of processors. The devices may include a main processor (e.g., an apps processor) and one or more coprocessors. As these devices are started or booted up, the devices may proceed through boot sequences. In some embodiments, the boot sequences may enable the coprocessors to start or boot independently of the apps processor. For example, in some smartphones, a display control processor may have an early boot environment that shows a splash screen. Later in the boot sequences, the operation of the processors may transition into a high level operating system (HLOS), which may run from the apps processor and may enable client apps to control the coprocessors.

In order to seamlessly transition to HLOS, the apps processor needs to know the status of the coprocessors. For example, if a coprocessor is not operating correctly, that coprocessor cannot transition control to HLOS. Therefore, a need exists for systems and methods that enable an apps processor to check the status of coprocessors during boot sequences.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Some aspects of the disclosure may be characterized a multiprocessor system including an apps processor configured to boot to a high level operating system (HLOS); a coprocessor configured to boot via a boot sequence and transition to the HLOS; and a shared memory wherein the shared memory is writable by the coprocessor during the boot sequence and readable by the apps processor, wherein the apps processor is further configured to modify the transition of the coprocessor to the HLOS in response to one or more signals written to the shared memory by the coprocessor.

Other aspects of the disclosure may be characterized as a multiprocessor system including an apps processor configured to boot to a high level operating system (HLOS); a first coprocessor configured to boot via a boot sequence and transition to the HLOS; a first shared memory wherein the first shared memory is writable by the first coprocessor during the boot sequence and readable by the apps processor; a second coprocessor configured to boot via a boot sequence and transition to the HLOS; and a second shared memory wherein the second shared memory is writable by the second coprocessor during the boot sequence and readable by the apps processor, wherein the apps processor is further configured to modify the transition of the first coprocessor and the second coprocessor to the HLOS in response to one or more signals written to the first shared memory by the first coprocessor and the second shared memory by the second coprocessor.

Other aspects of the disclosure may be characterized as a method of booting a system, wherein the system includes an apps processor and at least one coprocessor. The method includes commencing a boot sequence in the apps processor; commencing a boot sequence in a coprocessor; writing a status of the coprocessor during the boot sequence to a shared memory, wherein the shared memory is readable by the apps processor; reading the status of the coprocessor written in the shared memory by the apps processor; and adjusting a state of the coprocessor by the apps processor in response to the apps processor reading the status of the coprocessor.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings.

FIG. 1 illustrates a device including an apps processor and at least one coprocessor, wherein the coprocessor updates a boot status with the apps processor by writing a status to a shared memory according to one or more embodiments.

FIG. 2 illustrates a flowchart describing a method of booting a coprocessor of the device of FIG. 1 for transition to a high level operating system according to one or more embodiments.

FIG. 3 is a diagram illustrating a successful handover of a coprocessor to a high level operating system during boot up according to one or more embodiments.

FIG. 4 is a diagram illustrating an early watchdog crash detection in a coprocessor prior to a handoff to a high level operating system, wherein the coprocessor is restarted according to one or more embodiments.

FIGS. 5A-5B are a diagram illustrating an early watchdog crash detection or a fatal error in a coprocessor prior to a handoff to a high level operating system, wherein the coprocessor is subsequently restarted according to one or more embodiments.

FIGS. 6A-6B are a diagram illustrating a situation wherein a coprocessor was unresponsive after a handoff to a high level operating system and wherein the coprocessor is subsequently restarted according to one or more embodiments.

FIG. 7 illustrates a block diagram of an embodiment of a method of booting a multiprocessor system according to embodiments of the disclosure.

### DETAILED DESCRIPTION

Preliminary note: the flowcharts and block diagrams in the following figures illustrate the architecture, functionality, and operation of possible implementations of systems, methods and computer program products according to various embodiments of the present disclosure. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

The methods described in connection with the embodiments disclosed herein may be embodied directly in hardware, in processor-executable code encoded in a non-transitory tangible processor readable storage medium, or in a combination of the two.

In general, the memories described herein are non-transitory memories that functions to store (e.g., persistently store) data and processor-executable code (including executable code that is associated with effectuating the methods described herein). In some embodiments for example, the nonvolatile memory includes bootloader code, operating system code, file system code, and non-transitory processor-executable code to facilitate the execution of one or more methods described herein.

The present disclosure relates to methods and devices that start or boot up multiprocessor systems. The systems may be implemented in apparatuses, such as smartphones, computers, tablets, and other devices. A system may include a main processor, which may be referred to as an apps processor. The apps processor may cause one or more coprocessors to perform certain tasks. Examples of the coprocessors include, but are not limited to, a display control processor that operates a display on the smartphone and an audio digital signal processor that processes audio in the smartphone. In examples wherein the system is embodied in a smartphone, the apps processor may operate the smartphone at a high level, such as by a high level operating system (HLOS) and one or more coprocessors may operate specific functions in the smartphones. A non-limiting example of a HLOS is the Android operating system used in some smartphones. Thus, after the smartphone has fully started up, the coprocessors may operate in HLOS, which enables all the smartphone features, such as video displays and recording, audio, phone systems, and data communications to function properly.

A system may start or boot up by transitioning through a plurality of different boot environments, which may be referred to as a boot flow or a boot sequence. A boot sequence may commence with powering up of the system, which may initiate a bootloader or the like. In some embodiments, the bootloader may be initiated by a basic input output system (BIOS). The boot loader or other modules (i.e., software or firmware) in the system may transmit instructions to the processors that cause the processors to start or enter a boot sequence. In some embodiments, the bootloader may use a unified extensible firmware interface (UEFI) that may control early stages of the coprocessors during boot up and may start various subsystems in the coprocessors. In other embodiments, the boot sequence may transition to the UEFI, so the UEFI may be an intermediate boot environment. After exiting UEFI or other boot environments, control of the coprocessors is transferred to HLOS or other high level environments that enable apps and/or programs to control functions of the coprocessors. UEFI is a specification for a software program that connects firmware of a computer to the operating system of the computer. UEFI may be used in place of the basic input/output system (BIOS) but may be compatible with BIOS.

The methods and systems described herein provide communications of the status of the coprocessors to one or more shared memories, which may be read by the apps processor to determine the states of the coprocessors. The apps processor or the HLOS may then transition the coprocessors into HLOS with minimal delays, which improves the operation of the system. If errors are detected via the status written to the shared memory, the HLOS may take appropriate actions and may only restart the coprocessors if certain errors (e.g., fatal errors) are detected. In conventional systems, the HLOS may force coprocessors to restart during the transition to HLOS, which delays the startup of the system.

In some systems, the coprocessors may operate from two firmware images. A first firmware image may be executed during an initial portion of the boot sequence prior to the transition to HLOS. The second firmware image may be present in conventional system and may be executed after the HLOS restarts the system or after the coprocessor transitions to HLOS. The methods and systems described herein alleviate the need to restart coprocessors in most boot sequences, so there is no need to execute a first firmware image and a second firmware image.

The following description describes an example of the function of a display control processor (DCP) during a boot sequence. The DCP may be a coprocessor in a smartphone or other digital device (e.g., a multiprocessor system) that includes a display. Upon initialization of the smartphone, the bootloader or the apps processor may cause the DCP to start a boot up process. During this initial boot environment, the output of the display may be controlled by programs in the DCP. In some embodiments, the DCP may cause the display to show a splash screen early in the boot sequence. The splash screen may provide information to the user that the smartphone is powering up. As the boot sequence continues, operation of the DCP is passed to or transitioned to the HLOS so applications or programs executed by processors, such as an apps processor, in the smartphone may control the display by way of the DCP. The DCP may not need to be restarted during the transition to HLOS.

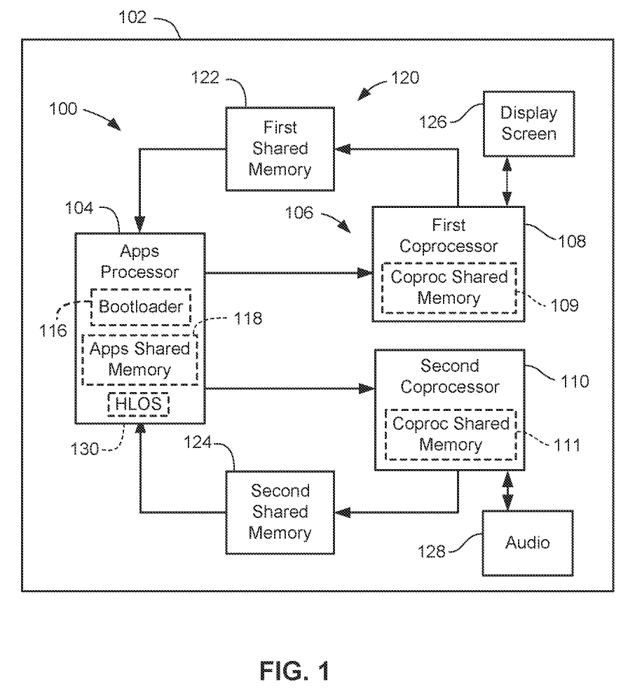

Reference is made to FIG. 1, which illustrates a simplified block diagram of a system 100 implemented in a device 102. The device 102 may, as examples, be a smartphone, a computer, a tablet, or other multiprocessor device that includes a plurality of processors. The system 100 may include an apps processor 104 and one or more coprocessors 106. The system 100 may be implemented as a system on chip (SoC) architecture. In the embodiment of FIG. 1, the system 100 includes two coprocessors, which are referred to individually as a first coprocessor 108 and a second coprocessor 110. The apps processor 104 may include a bootloader 116 that may initiate boot sequences or boot flows for the apps processor 104 and/or the coprocessors 106. In some embodiments, the bootloader 116 may be implemented as a bios and/or a UEFI. The apps processor 104 may also include an apps shared memory 118 that may be configured to read from and/or write to a shared memory 120 as described herein.

Each of the coprocessors 106 may include a coprocessor shared memory that enables the coprocessors 106 to share status with the shared memory 120 as described herein. The first coprocessor 108 may include a first coprocessor shared memory 109 and the second coprocessor 110 may include a second coprocessor shared memory 111.

As described above, the system 100 may include shared memory 120. In some embodiments, the system 100 may include individual shared memory associated with each of the coprocessors 106. In the embodiment of FIG. 1, the system 100 may include a first shared memory 122 associated with the first coprocessor 108 and a second shared memory 124 associated with the second coprocessor 110. Thus, the first coprocessor 108 may be configured to write its status to the first shared memory 122 and the second coprocessor 110 may be configured to write its status to the second shared memory 124. In other embodiments, other modules, such as one or more system monitors may cause the status of the coprocessors 106 to be written to the shared memory 120.

Having summarily described the system 100, the system 100 and the components of the system 100 will now be described in greater detail. The system 100 is described herein as being implemented in a smartphone. However, in other embodiments, the system 100 may be implemented in other devices, such as computers, tablets, and other devices that include multiple processors. In some embodiments, the first coprocessor 108 may be a display control processor (DCP) that operates a display screen 126 of the device 102. The second coprocessor 110 may be an audio digital signal processor (ADSP) that processes audio for audio devices 128. The audio devices 128 may include a microphone (not shown) and/or a speaker (not shown). The coprocessors 106 may ultimately operate per a high level operating system (HLOS) 130 that may be operated from the apps processor 104. The apps processor 104 may use the HLOS 130 or other operating systems to run apps and the like that operate the device 102. For example, the apps processor 104 may cause the coprocessors 106 to perform certain video and audio tasks via the HLOS 130. HLOS includes operating system that run on apps processors after an initial boot up. In some embodiments, HLOS may generally refer to a collective set of software that creates a necessary base for hardware to be useable by a user. Non-limiting examples of HLOS include Android, iOS, Windows, and QNX.

During the initial boot environment of a boot sequence, the first coprocessor 108 may, as an example, cause a splash screen to be displayed on the display screen 126. Code for operating the display screen 126 to show the splash screen may be firmware or software within the first coprocessor 108 or accessed by the first coprocessor 108. The second coprocessor 110 may, as an example, boot prior to the transition to the HLOS 130 to expose charger functionality in UEFI or other early boot environments. In some embodiments, the second coprocessor 110 may generate sounds via the audio devices 128 prior to the transition to the HLOS 130. After exiting the early boot environments, the HLOS 130 needs to take control of the coprocessors 106 to enable the apps to operate the coprocessors 106 and their associated hardware.

The bootloader 116 may be firmware or software that runs on the apps processor 104 and the coprocessors 106 to commence boot sequences in response to the system 100 and/or the device 102 being initialized (e.g., powered up). In some embodiments, the bootloader 116 may be firmware or software that generates signals that cause devices to start. As the boot sequences progress, the HLOS 130 transitions to be the operating system that operates the system 100 and may interact and/or control/manage the coprocessors 106.

During the boot sequences, the coprocessors 106 may generate signals or bits indicating their progress or status during their respective boot sequences. These signals may be written to and stored in the respective shared memory 120 of the individual coprocessors 106 and accessed by the apps processor 104. For example, as the first coprocessor 108 proceeds through a boot sequence to the HLOS 130, the first coprocessor 108 or other module may update certain bits in the first shared memory 122 that indicate the status of the first coprocessor 108 through the boot sequence. Likewise, as the second coprocessor 110 proceeds through the boot sequence to the HLOS 130, the second coprocessor 110 or other module may update certain bits in the second shared memory 124 that indicate the status of the second coprocessor 110 through the boot sequence. The shared memory 120 may be accessible (e.g., readable) by the apps processor 104. In some embodiments, a handshake between the shared memory 120 and the apps processor 104 may generate instructions informing the apps processor 104 that there are signals (e.g., bits) stored in the shared memory 120 and ready to be read. The apps processor 104 may then read the bits stored in the shared memory 120 and take appropriate actions related to the coprocessors 106 as described herein. For example, the actions may modify the transition of control of a coprocessor to the HLOS 130 in response to one or more signals written to the shared memory 120 by the coprocessor. Modification includes restarting the coprocessor. In some embodiments, the bits define a set of standardized signals so the state of the coprocessors 106 can be inferred at different stages of the boot sequences.

In some embodiments, the shared memory 120 may be a shared memory point-to-point (SMP2P) protocol or a shared memory protocol that functions in a manner similar to the SMP2P protocol. The SMP2P protocol facilitates communication of a value, such as a single thirty-two bit value, between two processors. Values other than 32-bit values may be used. The communication may be between one of the coprocessors 106 and the apps processor 104. Each value may have a single writer, which may be referred to as the local side (coprocessors 106), and a single reader, which may be referred to as the remote side (the apps processor 104). Values may be uniquely identified in the system 100 by a directed edge (local processor ID to remote processor ID) and a string identifier. Each of the coprocessors 106 may be responsible for creating an outgoing shared memory (SMEM) item and each item may be writable by the local processor and readable by the remote processor. By using two separate SMEM items that are single-reader and single-writer, the SMP2P does not require any remote locking mechanisms. A driver may use a Linux general purpose input/output (GPIO) and interrupt framework to expose a virtual GPIO for each outbound entry and a virtual interrupt controller for each inbound entry.

As more coprocessors are loaded in earlier boot stages and are required to transition into HLOS 130 without being restarted, there is a need for passing the status of the coprocessors 106 across the boot stages so the HLOS 130 can perform various tasks. In some embodiments, the HLOS 130 may perform tasks to update the status of the coprocessors 106 in a HLOS/User context. In some embodiments, the HLOS 130 may notify clients about the availability of one or more of the coprocessors 106. In other embodiments, the HLOS 130 may take corrective actions in case an early crash of a coprocessor is detected. Actions may include a coprocessor restart. In yet other embodiments, the HLOS 130 may collect debug information to allow for debugging of early boot crashes.

### SMP2P Requirements

In some embodiments where the shared memory 120 uses a SMP2P protocol, a conventional SMP2P protocol may need some revisions to operate in the system 100. In some embodiments, some SMP2P protocols may need a handshake before allowing it to run. In some other embodiments, when the coprocessors 106 are booting, the coprocessor shared memories in the coprocessors 106 may need to write items to the shared memory 120 even if no SMP2P handshake has occurred. On the apps processor 104 side (sometimes referred to as the apps side), SMPbP may need to handle the handover of coprocessor status information across one or more boot stages. The handover handshake may be symmetrical to the existing SMP2P subsystem restart handshake. The apps side SMP2P may have to detect if an earlier boot stage has initialized an SMP2P handshake. For example, the apps side SMP2P may detect whether a UEFI detected a handshake.

Any SMP2P items on the apps side from previous SMP2P sessions may be cleared and the coprocessor may be notified with a handover/SSR handshake or similar function. It is noted that the term subsystem reset (SSR) refers to restarting or resetting a coprocessor. If the coprocessor is operational, the coprocessor and/or the apps processor 104 may notify registered clients that the coprocessor is functional and clear any shadow copies of the SMP2P items in its control. On the apps side, the SMP2P may need to provide an application programming interface (API) for clients to read one or more SMP2P items and retrieve the contents of the one or more items. In some embodiments, a client of this framework may read the contents of a slave kernel (e.g., a primary/secondary kernel)item to parse the bits of interest in the SMP2P (the shared memory 120). These changes to the conventional SMP2P may minimize impact on existing SSR handshakes and SMP2P cleanup.

### Interrupts

Interrupts may be handled in specific manners with regard to the shared memory 120. In some embodiments, the shared memory 120 may use interrupts dedicated for inter-processor communication (IPC) to generate signals between the apps processor 104 and the coprocessors 106. Any interrupt generated by one or more of the coprocessors 106 and left in a pending state across boot stages may need to be properly handled by protocols associated with the apps processor 104. In some embodiments, interrupts may not result in shared memory updates to apps clients until the handover handshake with the relevant coprocessor is completed. If a watchdog (WDOG) bite interrupt is pending in one or more of the coprocessors 106, the crash may be detected by the HLOS via the status handover framework in the shared memory 120 and upon a subsystem reset (SSR), a secure monitor call (SMC) to shut down the affected coprocessor may result in the pending interrupt being cleared. In some embodiments, if a signal to the shared memory 120 is transmitted via an interrupt signal, the interrupt state may not be cleared when the apps processor 104 transitions to the later stages of the boot sequences. In some embodiments, the shared memory 120 may not be reset when the coprocessors 106 transition between boot stages.

### Shared Memory Bit Assignment

Clients or the apps processor 104 may assign a meaning to each bit in the shared memory 120. In the embodiments described herein, the at least some of the bits in the first shared memory 122 and the second shared memory 124 may represent at least a fatal error (error_fatal) signal, a clock ready (clock_ready) signal, and an error ready (error_ready) signal. A fatal error means the coprocessor has crashed in a fatal manner and will be restarted. The apps processor 104 may perform a cleanup routine when a fatal error occurs. The clock ready signal means the coprocessor has finished booting to a point where the coprocessor can manage its own clock resources. In response to the clock ready signal, the apps processor 104 may remove any proxy votes on resources. The error ready signal means the coprocessor has finished booting to a point where the coprocessor can report errors on its own. The apps processor 104 may use the error ready signal as a benchmark that the coprocessor has booted successfully. Prior to the error ready signal being generated, a system monitor or the like may report errors in the coprocessor to the shared memory 120.

### Generalizations And Overview

Some embodiments of the system 100 may include an apps processor 104 and/or coprocessors 106 with certain attributes as described below. Images of the coprocessors 106 may have functionality with protocols of the shared memory 120, such as SMP2P or system monitoring (SYS_M) functionality. Boot stages, such as in UEFI and HLOS, that use the handover framework may need SMP2P support. The coprocessors 106 may need the ability to vote for their own resources and if not, the coprocessors 106 may need their respective boot loaders to apply the required proxy votes. In general, after being taken out of reset (i.e., having been started or restarted), the coprocessors 106 may initialize err handlers, enable WDOG, and initialize the coprocessors 106 very early in the initialization (boot) process.

Crashes that happen before error handlers are initialized and watchdog (WDOG) is enabled may go unnoticed by the HLOS 130 unless the boot loader or clients are monitoring the boot sequence via the bits in the shared memory 120 or polling (e.g., pinging) for “signs of life” in the coprocessors 106. The handover framework of the shared memory 120 may handle this use case. Crashes that occur after WDOG is enabled and err handlers are initialized may have status and debug information already saved in bits of the shared memory 120 and, in some embodiments, a coprocessor software failure reason (SFR) may be initialized in the shared memory 120. A WDOG bite may trigger an interrupt that can be used to handle the crash if an entity is registered for the WDOG bite. A fatal error may update the SFR with a different or updated failure reason and may set one or more bits in the shared memory 120 indicating that the fatal error has occurred. The one or more fatal error bits may trigger an IPC interrupt to be sent to the apps shared memory 118. In some embodiments, after a fatal error occurs, an error handler in the coprocessor may wait a predetermined period (e.g., two seconds) before forcing a WDOG bite.

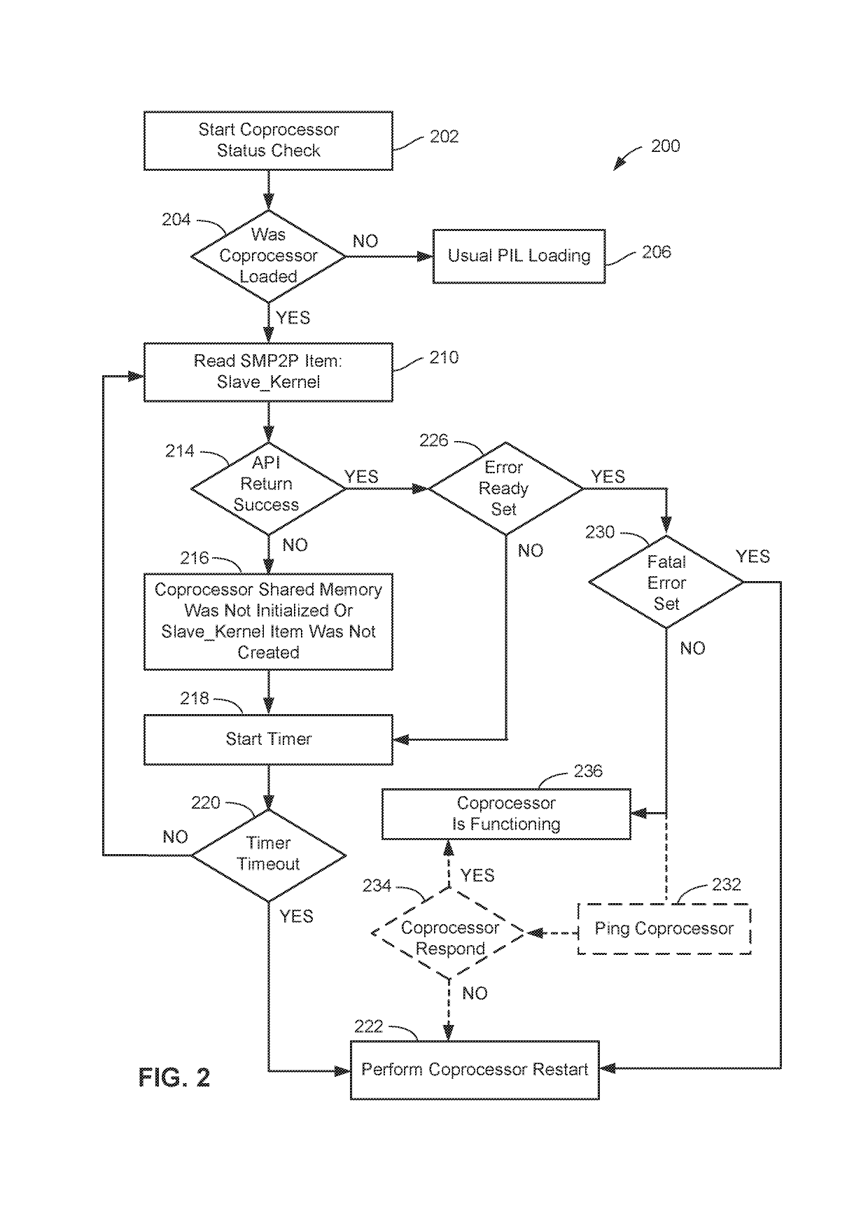

Having described the components of the system 100, the operation of the system 100 and the device 102 will now be described. Additional reference is made to FIG. 2, which illustrates a flowchart describing a method 200 of booting the system 100 through a boot sequence. It is noted that the method 200 only illustrates a small portion of a typical boot sequence and is only related to the coprocessors 106 booting and providing status updates to the apps processor 104 during the different boot stages. By using the shared memory 120 as described herein, the coprocessors 106 may seamlessly transition between boot stages and continue any processing done prior to boot by the HLOS 130. For example, in many situations, one or more of the coprocessors 106 may not need to restart upon transitioning to HLOS.

The description of the boot sequence and the method 200 is described relative to the first coprocessor 108. However, it is to be understood that the boot sequence and the method 200 described herein are applicable to the second coprocessor 110 and other coprocessors that may be in or coupled to the device 102 and/or the system 100. The method 200 may commence at operational block 202 where a status check of the first coprocessor 108 commences. The status check may analyze different items associated with the first coprocessor 108. For example, the status check may determine whether firmware associated with the first coprocessor 108 has been loaded (e.g., started). Decision block 204 may then determine whether the first coprocessor 108 was loaded. If the first coprocessor 108 is not loaded, processing may proceed to operational block 206 where usual PIL or another firmware loading occurs. After loading, the method 200 may return to operational block 202. In some embodiments, loading may be initiated by signals generated by the apps processor 104.

If, in decision block 204, the first coprocessor 108 has been determined to be loaded, processing proceeds to operational block 210 wherein an item from the first shared memory 122, which may be SMP2P shared memory, is read. The item may be read via a slave kernel. The item may be identified as one or more bits written to the first shared memory 122 indicating the status of the first coprocessor 108. In some embodiments, the first shared memory 122 may be read via an API. The one or more bits may be status indicating one or more of a fatal error, a clock ready, and an error ready signal. Other signals may be used to transmit status of the first coprocessor 108 to the apps processor 104. In decision block 214, a determination is made as to whether the API was successful in reading the shared memory item.

If the result of decision block 214 is negative, the first coprocessor shared memory 109 was not initialized or the slave kernel item was not created as shown in operational block 216. Processing then proceeds to operational block 218 where a timer may be started. The timer provides the system 100 a predetermined time to wait for the issues in operational block 216 to clear. The timer also may be used to provide time for other issues with the coprocessor to clear. Decision block 220 determines whether the timer in operational block 218 has timed out without resolving the issues in operational block 216. If the timer has not timed out, processing returns back to operational block 210 to read the item in the first shared memory 122. If the outcome of decision block 220 is negative, then the first coprocessor 108 did not start or boot correctly and processing proceeds to operational block 222 where the first coprocessor 108 is restarted.

Returning to decision block 214, if the outcome of decision block 214 is positive, processing proceeds to decision block 226 where a decision is made as to whether the error ready signal has been set (e.g., written to the first shared memory 122). As described above, the error ready signal means the first coprocessor 108 has proceeded booting to a point where the first coprocessor 108 can report errors on its own. If the outcome of decision block 226 is negative, the first coprocessor 108 has not reached a point in the boot sequence where the first coprocessor 108 can report errors. Processing then proceeds to operational block 218 where more time is given for the first coprocessor 108 to reach a point in the boot sequence where the first coprocessor 108 can report errors.

If the outcome of decision block 226 is positive, then the first coprocessor 108 is in a state in the boot sequence where the first coprocessor 108 can report errors. Processing then proceeds to decision block 230 where a determination is made as to whether the fatal error signal has been written to the first shared memory 122. If the outcome of decision block 230 is affirmative, the first coprocessor 108 has encountered a fatal error that cannot be rectified, so processing proceeds to operational block 222 where the first coprocessor 108 is restarted.

If the outcome of decision block 230 is negative, the first coprocessor 108 is functioning as shown in operational block 236. The first coprocessor 108 may then transition to HLOS. In some embodiments, decision block 230 may indicate that the first coprocessor 108 is in the clock ready state, meaning the first coprocessor 108 has finished booting to a point where the first coprocessor 108 can manage its own clock resources. In some embodiments, processing may proceed to operational block 232 to ping the first coprocessor 108 if the outcome of decision block 230 is negative. The ping may be an additional operation to determine if the first coprocessor 108 has remained active after writing to the first shared memory 122 indicating that it is operating properly. Processing then proceeds to decision block 234 to determine whether the first coprocessor 108 responded to the ping. If the outcome of decision block 234 is positive, the first coprocessor 108 is operating as shown in decision block 230. If, on the other hand, the outcome of decision block 234 is negative, the first coprocessor 108 is not functioning and processing proceeds to operational block 222 where the first coprocessor 108 is restarted.

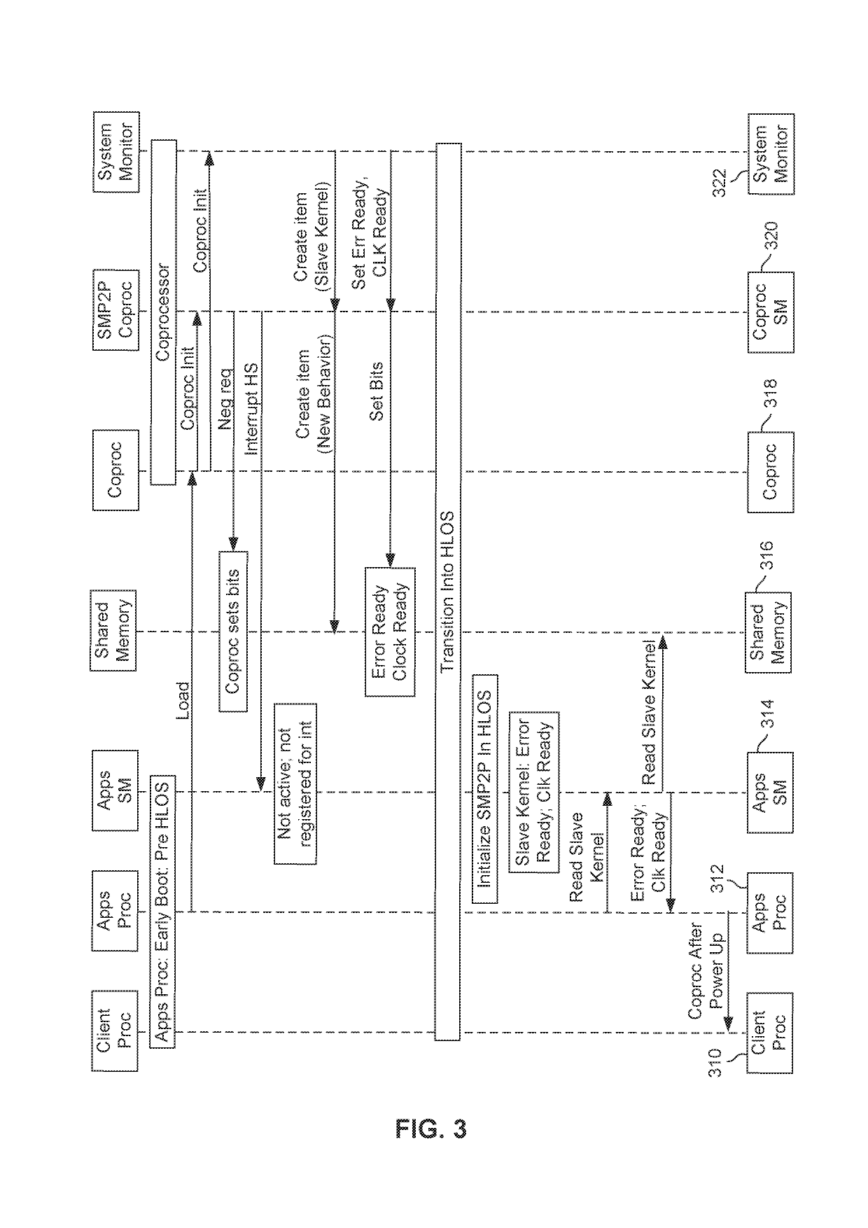

Reference is now made to FIGS. 3-6B, which are diagrams illustrating different HLOS handover situations between a coprocessor (coproc) and an apps processor during different stages of boot sequences. The boot sequences illustrated in FIGS. 3-6B proceed from the tops of the diagrams to the bottoms of the diagrams. The diagrams include different components of the system 100 of FIG. 1 and may operate per the method 200 (FIG. 2). The embodiments of FIGS. 3-6B include a client processor 310, an apps processor 312, an apps shared memory 314, a shared memory 316, a coprocessor 318, a coprocessor shared memory 320, and a system monitor 322. The diagrams may be directed to the first coprocessor 108, so the shared memory 316 may refer to the first shared memory 122 and the coprocessor shared memory 320 may refer to the first coprocessor shared memory 109. The system monitor may be a program or the like running in the coprocessor 318 or coupled to the coprocessor 318 that monitors the coprocessor 318 through at least a portion of the boot sequence.

Reference is made to FIG. 3, which is a diagram illustrating a successful handover of the coprocessor 318 to a HLOS during a boot sequence according to one or more embodiments. The boot sequence may commence with the apps processor 312 starting an early boot process in the apps processor 312 and the coprocessor 318. The coprocessor 318 may be initialized, which may be recorded by the system monitor 322. The coprocessor shared memory 320 may create an item (e.g., a new behavior) or error ready and clock ready signals, which are transferred to the shared memory 316. For example, certain bits in the shared memory 316 may be set by the system monitor 322 indicating that the coprocessor 318 is ready to report errors on its own (error ready signal) and ready to continue processing (clock ready signal).

The system 100 may then transition to HLOS. The HLOS may be initialized in the apps shared memory 314. A slave kernel may read the bits set in the shared memory 316 to determine that the error ready and clock ready signals are set in the coprocessor 318, which indicates that the coprocessor 318 is ready to transition to HLOS. The apps processor 312 may indicate to the client processor 310 that the coprocessor 318 is ready to operate via the HLOS. The device 102 (FIG. 1) may then operate in HLOS using the coprocessor 318.

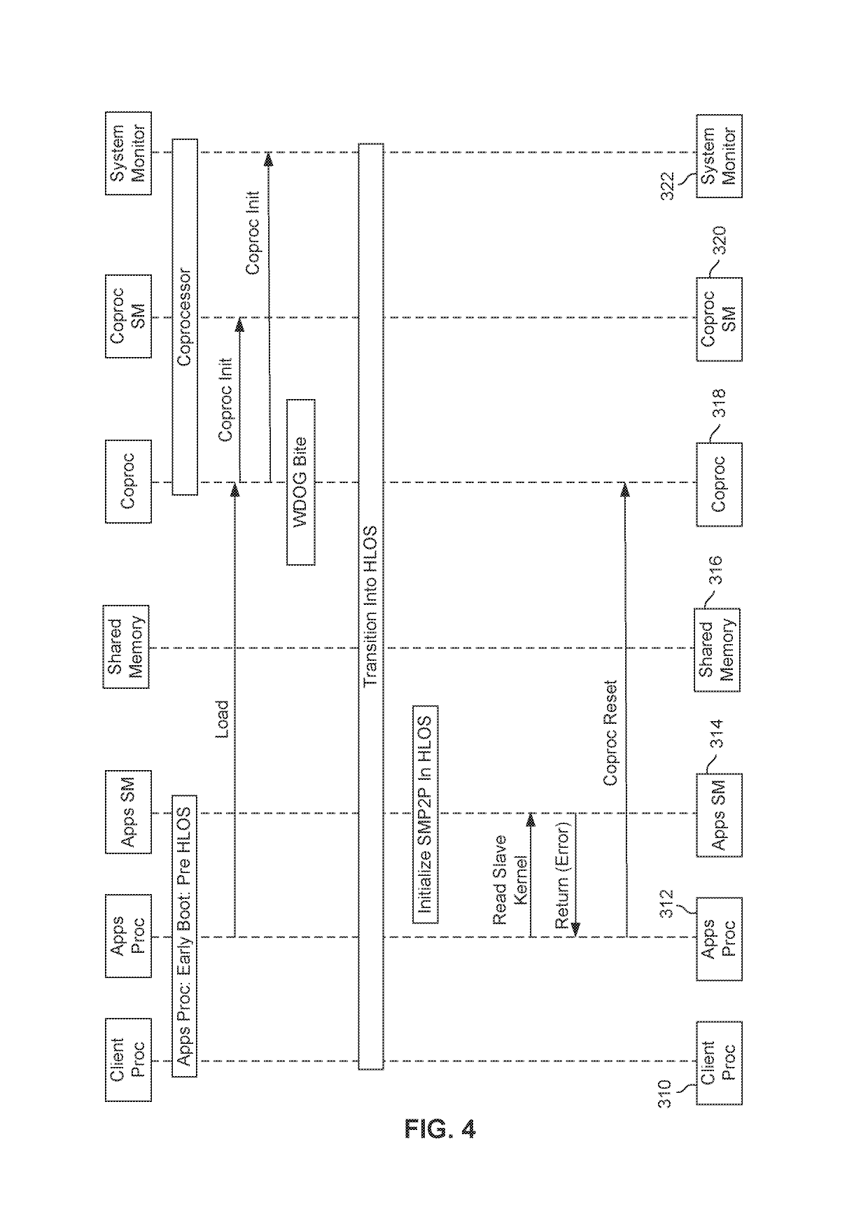

Reference is now made to FIG. 4, which is a diagram illustrating an early watchdog (WDOG) crash detection in the coprocessor 318 prior to a handoff to the HLOS, wherein the coprocessor 318 is eventually restarted. As with the process described in FIG. 3, the apps processor 312 may start or initialize the coprocessor 318. The coprocessor 318 or a module coupled to the coprocessor may run a watchdog (WDOG) type program that generates a signal (e.g., a WDOG bite) if the coprocessor 318 has not operated or has remained idle for a predetermined period. In some embodiments, the predetermined period is two seconds. Other predetermined periods may be used. In the embodiment of FIG. 4, the coprocessor 318 has remained idle for the predetermined period, which causes the WDOG bite signal to be generated. In this embodiment, the WDOG bite signal is indicative of a fatal error in the coprocessor 318. The WDOG bite signal may be illustrated in decision block 220 of FIG. 2 where the timer has timed out, which causes the coprocessor 318 to be restarted. In some embodiments, the WDOG bite signal may be generated by the system monitor 322.

Bits may be set in the shared memory 316 indicating that the WDOG bite signal has been generated. In other embodiments, no bits may be set in the shared memory 316, which may be interpreted by the apps processor 312 as a fatal error in the coprocessor 318. After the apps processor 312 transitions to HLOS, the slave kernel may read an error signal in the apps shared memory 314 and/or the shared memory 316. The error signal may cause the apps processor 312 to restart the coprocessor 318. After being restarted, the coprocessor 318 may boot into HLOS.

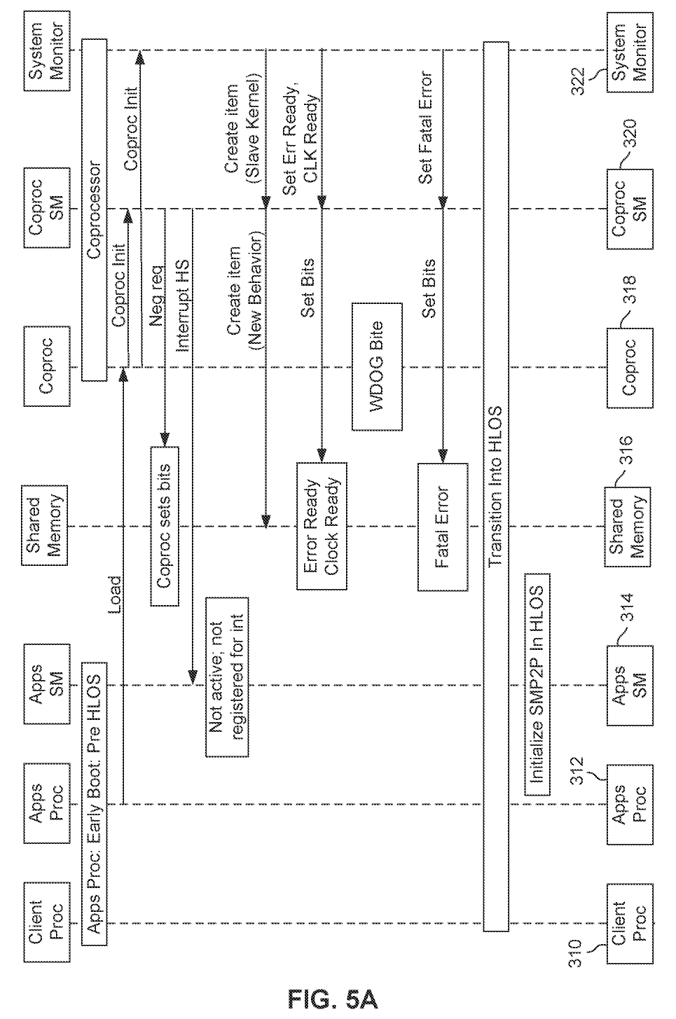

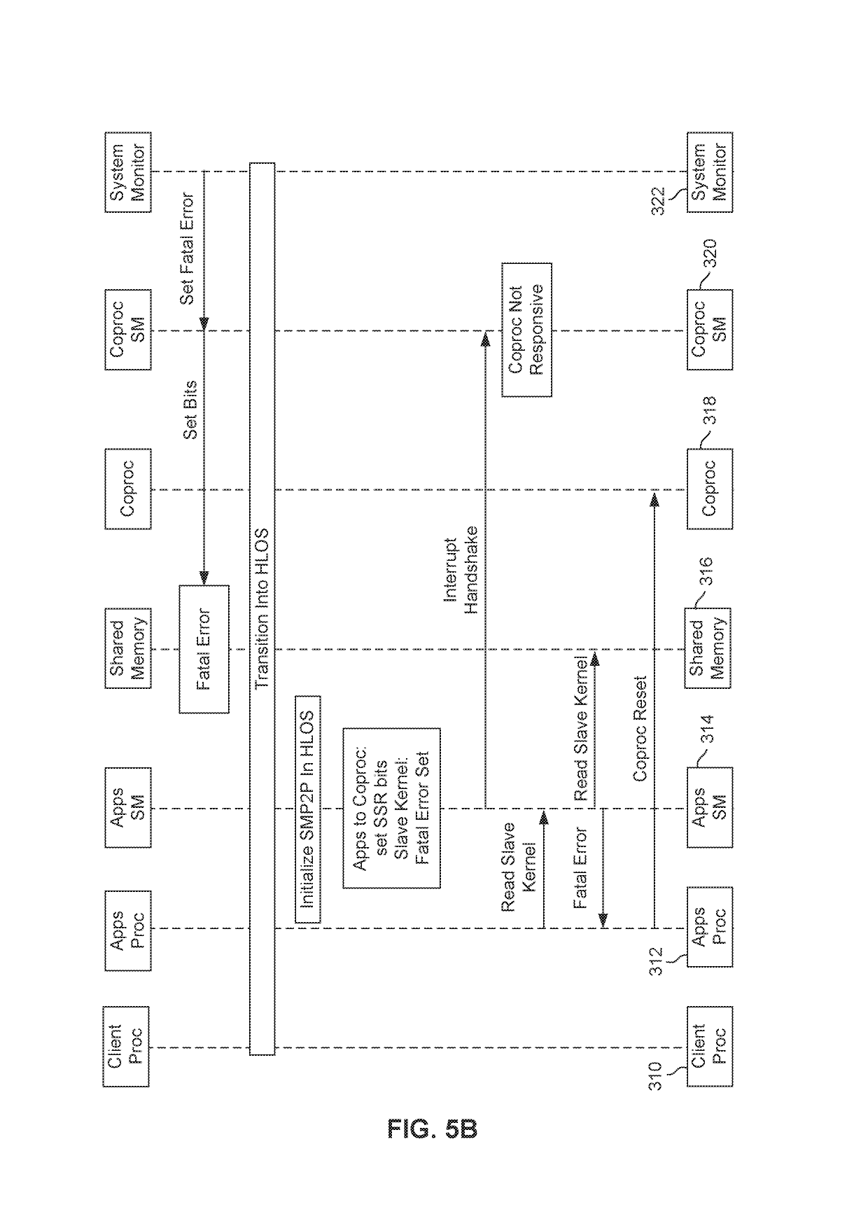

Reference is now made to FIGS. 5A-5B, which are a diagram illustrating an early watchdog crash detection or a fatal error detection in the coprocessor 318 prior to a handoff to the HLOS, wherein the coprocessor 318 is subsequently restarted. In the embodiment of FIGS. 5A-5B, the boot sequence starts as described above in FIG. 3. After the error ready and clock ready bits have been set in the shared memory 316, the coprocessor 318 encountered an error that caused the WDOG bite signal to be generated. For example, the coprocessor 318 may have remained idle for a predetermined period, which may have caused the WDOG bite signal to be generated by the coprocessor 318 and/or the system monitor 322. In response to the WDOG bite signal, the system monitor 322 causes one or more bits in the shared memory 316 to be set indicating that a fatal error has occurred in the coprocessor 318.

After the transition to HLOS, the apps shared memory 314 may read the fatal error signal set in the shared memory 316. In some embodiments, the apps shared memory 314 may commence a handshake, such as an interrupt handshake, with the coprocessor shared memory 320. Because the coprocessor 318 has suffered a fatal error, the coprocessor 318 and/or the coprocessor shared memory 320 is not responsive to the handshake. The slave kernel or other program may generate a signal to the apps processor 312 that the coprocessor 318 is not responsive. The apps processor 312 may then generate a signal causing the coprocessor 318 to reset (e.g., restart). This error may be similar to the situation in decision block 230 of FIG. 2 where the fatal error is set.

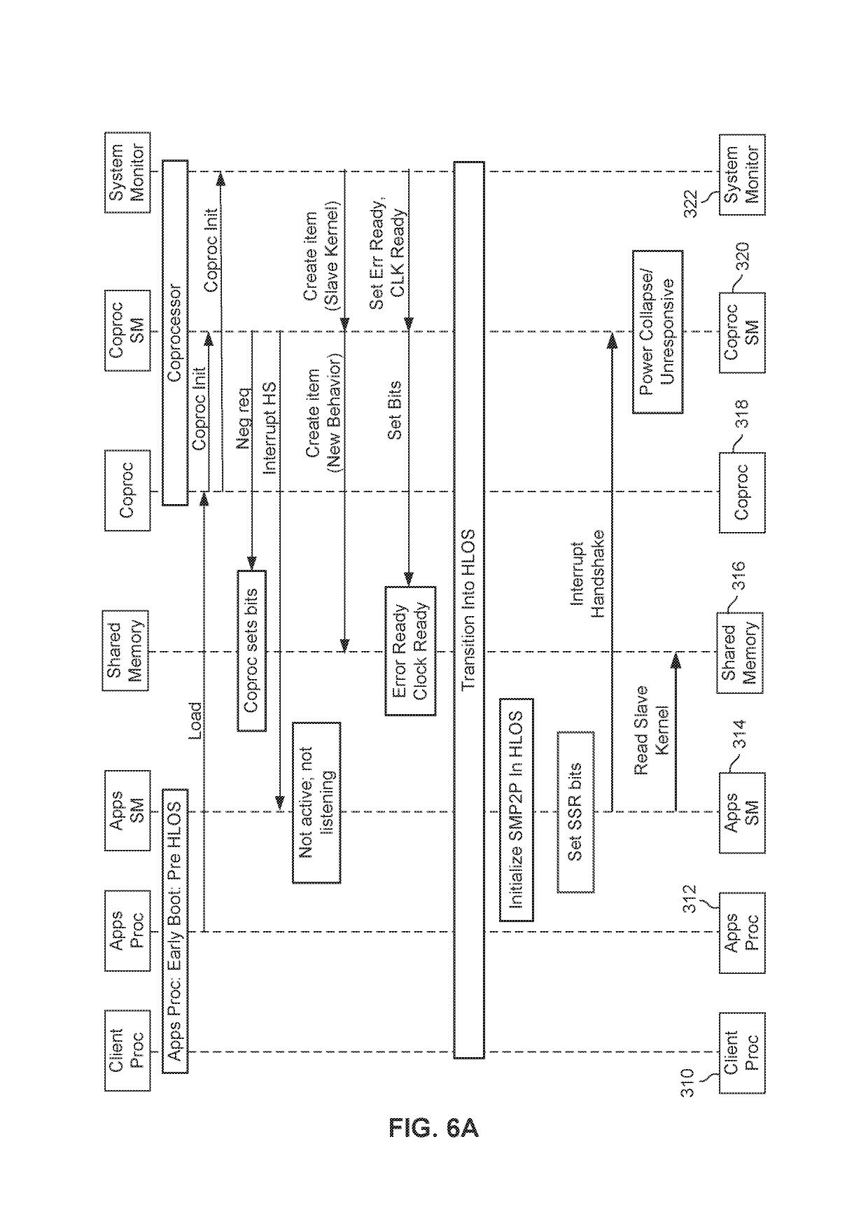

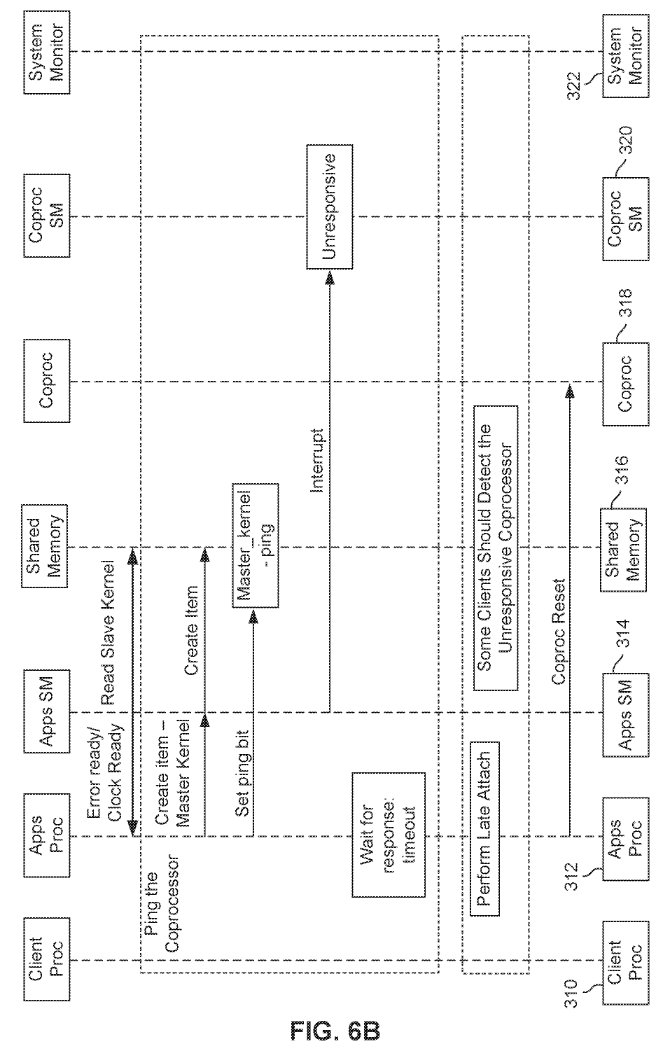

Reference is made to FIGS. 6A-6B, which are a diagram illustrating a situation wherein the coprocessor 318 is unresponsive after a handoff to HLOS and wherein the coprocessor 318 is subsequently restarted. This situation may be similar to operational block 232 and decision block 234 in FIG. 2 wherein the apps processor 312 pings the coprocessor 318 after the transition to HLOS. In the embodiments of FIGS. 6A-6B, the system monitor 322 has set error ready and clock ready signals in the shared memory 316 prior to the transition to HLOS. After the transition to HLOS, the apps shared memory 314 may commence a handshake with the coprocessor shared memory 320. In this embodiment, the coprocessor 318 and/or the coprocessor shared memory 320 is not responsive, so there is no response from the coprocessor 318 and/or the coprocessor shared memory 320. The slave kernel may read the shared memory 316 and determine that the error ready and clock ready signals have been set.

In this embodiment, the apps processor 312 may initiate a ping signal to the coprocessor 318. However, the coprocessor 318 has suffered an error and will not respond. The apps processor 312 may wait for predetermined time for a response before a timeout signal is generated. The apps processor 312 may then cause the coprocessor 318 to restart. The client processor 310 may receive a signal indicating the failure of the coprocessor 318 and may proceed accordingly.

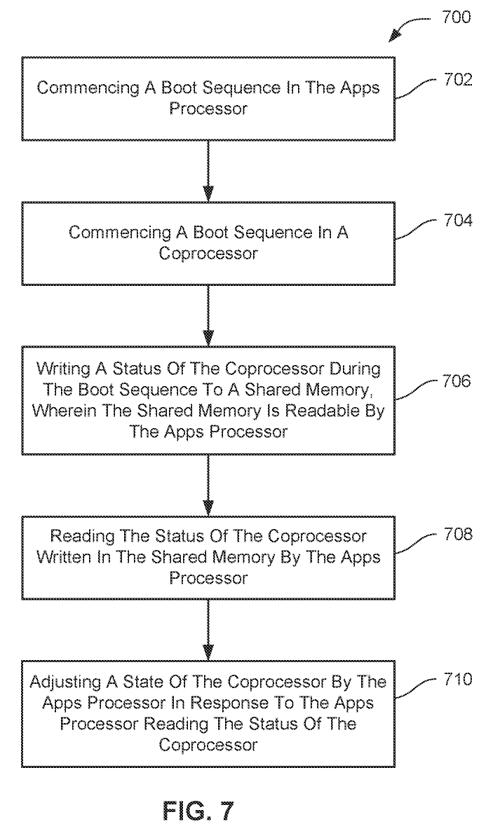

Reference is made to FIG. 7, which is a flowchart illustrating a method of booting a system (e.g., system 100), wherein the system comprises an apps processor (e.g., apps processor 104) and at least one coprocessor (e.g., first coprocessor 108). The method 700 includes, in block 702, commencing a boot sequence in the apps processor. The method 700 includes, in block 704, commencing a boot sequence in a coprocessor. The method 700 includes, in block 706, writing a status of the coprocessor during the boot sequence to a shared memory (e.g., first shared memory 122), wherein the shared memory is readable by the apps processor. The method 700 includes, in block 708, reading the status of the coprocessor written in the shared memory by the apps processor. The method 700 includes, in block 710 adjusting a state of the coprocessor by the apps processor in response to the apps processor reading the status of the coprocessor.

As used herein, the recitation of "at least one of A, B and C" is intended to mean "either A, B, C or any combination of A, B and C." The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the principles and novel features disclosed herein.

What is claimed is:

1. A multiprocessor system comprising:
an apps processor configured to boot to a high level operating system (HLOS);
a coprocessor configured to boot via a boot sequence and transition to the HLOS; and
a shared memory wherein the shared memory is writable by the coprocessor during the boot sequence and readable by the apps processor,
wherein the apps processor is further configured to modify the transition of the coprocessor to the HLOS in response to one or more signals written to the shared memory by the coprocessor.

2. The system of claim 1, wherein the coprocessor is configured to write a status of the coprocessor to the shared memory across one or more boot stages of the boot sequence.

3. The system of claim 1, wherein the shared memory is a shared memory point-to-point framework.

4. The system of claim 3, wherein the shared memory comprises a single value of bits between the apps processor and the coprocessor.

5. The system of claim 4, wherein the shared memory comprises a single value of thirty-two bits.

6. The system of claim 1, wherein the one or more signals written by the coprocessor comprises a clock ready signal.

7. The system of claim 1, wherein the one or more signals written by the coprocessor comprises an error ready signal.

8. The system of claim 1, wherein the one or more signals written by the coprocessor comprises a fatal error signal.

9. A multiprocessor system comprising:
an apps processor configured to boot to a high level operating system (HLOS);
a first coprocessor configured to boot via a boot sequence and transition to the HLOS;
a first shared memory wherein the first shared memory is writable by the first coprocessor during the boot sequence and readable by the apps processor;
a second coprocessor configured to boot via a boot sequence and transition to the HLOS; and
a second shared memory wherein the second shared memory is writable by the second coprocessor during the boot sequence and readable by the apps processor,
wherein the apps processor is further configured to modify the transition of the first coprocessor and the second coprocessor to the HLOS in response to one or more signals written to the first shared memory by the first coprocessor and the second shared memory by the second coprocessor.

10. The system of claim 9, wherein the first coprocessor is configured to write a status of the first coprocessor to the first shared memory across one or more boot stages of the boot sequence and wherein the second coprocessor is configured to write a status of the second coprocessor to the second shared memory across one or more boot stages of the boot sequence.

11. The system of claim 9, wherein at least one of the first shared memory and the second shared memory is a shared memory point-to-point framework.

12. The system of claim 11, wherein at least one of the first shared memory and the second shared memory comprises a single value of bits between the apps processor and a corresponding first coprocessor and second coprocessor.

13. The system of claim 9, wherein the first shared memory comprises a single value of thirty-two bits.

14. The system of claim 9, wherein the one or more signals written by the first coprocessor to the first shared memory comprises a clock ready signal.

15. The system of claim 9, wherein the one or more signals written by the first coprocessor to the first shared memory comprises an error ready signal.

16. The system of claim 9, wherein the one or more signals written by the first coprocessor to the first shared memory comprises a fatal error signal.

17. A method of booting a system, wherein the system comprises an apps processor and at least one coprocessor, the method comprising:
commencing a boot sequence in the apps processor;
commencing a boot sequence in a coprocessor;
writing a status of the coprocessor during the boot sequence to a shared memory, wherein the shared memory is readable by the apps processor;
reading the status of the coprocessor written in the shared memory by the apps processor; and
adjusting a state of the coprocessor by the apps processor in response to the apps processor reading the status of the coprocessor.

18. The method of claim 17, wherein writing a status comprises writing a status indicating a fatal error in the coprocessor and wherein the adjusting comprises restarting the coprocessor.

19. The method of claim 17, wherein writing a status comprises writing a status indicating the coprocessor is operating properly and further comprising booting the coprocessor to a high level operating system of the apps processor.

20. The method of claim 17, wherein writing a status comprises writing a status indicating the coprocessor is operating properly and further comprising:
transmitting a ping signal to the coprocessor;
booting the coprocessor to a high level operating system of the apps processor in response to the ping signal being returned from the coprocessor; and
restarting the coprocessor in response to the ping signal not being returned from the coprocessor.
